(19) United States
(12) Patent Application Publication
(10) Pub. No.: US 2017/0226609 A1
(43) Pub. Date: Aug. 10, 2017

(54) METHOD FOR PRODUCTION OF A NITRIDED PACKAGING STEEL

(71) Applicants: ThyssenKrupp Rasselstein GmbH, Andernach (DE); THYSSEBKRUPP AG, Essen (DE)

(72) Inventors: Blaise MASSICOT, Burgbrohl (DE); Manuel KÖHL, Mendig (DE); Burkhard KAUP, Andernach (DE); Reiner SAUER, Heimbach-Weis (DE); Ricarda KLEMMER, Bonn (DE); Chrysanthus KIEWITZ, Remagen (DE)

(73) Assignee: ThyssenKrupp Rasselstein GmbH, Andernach (DE)

(21) Appl. No.: 15/518,905

(22) PCT Filed: Aug. 3, 2015
(86) PCT No.: PCT/EP2015/067835

§ 371 Date: Apr. 13, 2017

(30) Foreign Application Priority Data
Nov. 19, 2014 (DE) 10 2014 116 929.8

(51) Int. Cl. C21D 9/46; C21D 8/02; C21D 1/76; C21C 7/00; F27D 3/16; C21D 1/42; C21D 1/40; F27D 11/04; F27D 11/06; C23C 8/26; C21D 9/00

(52) U.S. Cl. CPC C21D 9/46; C23C 8/26; C21D 8/0226; C21D 8/0236; C21D 8/0273; C21D 1/76; C21C 7/00; C21D 9/0062; C21D 1/42; C21D 1/40; F27D 11/04; F27D 11/06; F27D 3/16; F27D 2003/166

(57) ABSTRACT

A method for producing a nitrided packaging steel from a hot-rolled steel product with a carbon content of 400 to 1200 ppm, utilizing a cold-rolling of the steel product to a flat steel product, subsequent recrystallization annealing of the cold-rolled flat steel product in an annealing furnace, in particular a continuous annealing furnace. A nitrogen-containing gas is supplied into the annealing furnace and is directed at the flat steel product to introduce unbonded nitrogen into the flat steel product in an amount corresponding to a concentration of more than 100 ppm, or to increase the amount of unbonded nitrogen in the flat steel product to a concentration of more than 100 ppm, and subsequent cooling of the recrystallized annealed flat steel product at a cooling rate of at least 100 K/s directly after the recrystallization annealing. Using this method, cold-rolled flat steel products may be produced for packaging purposes with a tensile strength of more than 650 MPa and in particular between 700 and 850 MPa.

### FIELD OF THE INVENTION

The invention concerns a method for the production of a nitrided packaging steel and a packaging steel produced with the method in the form of cold-rolled flat steel product.

### BACKGROUND

It is known from the prior art to increase the strength of steels by incorporating unbonded nitrogen dissolved in the steel. Incorporation of unbonded nitrogen in steel is referred to as nitriding and represents a known method for the hardening of steel and steel products.

The nitriding of flat steel products, like steel sheet or steel strips, which are prescribed for the production of packaging (subsequently referred to as packaging steel), is also known from the prior art. For example, a steel sheet for packaging purposes and a method for its production are described in EP 0 216 399 B1, the steel sheet being produced from an aluminum-killed, continuously cast carbon-manganese steel and having acquired an amount of unbonded dissolved nitrogen by nitriding in which the minimum amount of unbonded nitrogen is defined as a function of the desired hardness category of the steel sheet (for example, hardness category T61 of the European Standard 145-78) and has an amount of unbonded nitrogen of at least 5 ppm. The chemical composition of the steel sheet disclosed there with respect to carbon and manganese content corresponds to the usual soft steels and has a carbon content in the range of 0.03 to 0.1 wt % and a manganese content from 0.15 to 0.5 wt %. The steel sheet is characterized by a high yield point in the range 350-550 N/mm². A maximum value of 100 ppm is stated for the amount of unbonded nitrogen dissolved in the steel and is justified by the fact that steel sheet with a high content of unbonded nitrogen can no longer be cold rolled because of the strength increase related thereto and is therefore not suitable for the proposed use as cold-rolled packaging steel.

In the method for the production of this known packaging steel, a steel is initially continuously cast, then hot rolled, cold rolled, recrystallization annealed and finally temper rolled. Thermal post-treatment occurs after temper rolling, in which free dislocations that are formed in this steel by temper rolling are fixed by the unbonded nitrogen introduced by nitriding in order to increase the hardness and yield point above the values after temper rolling. Thermal post-treatment can then expediently be combined with another thermal treatment of the temper-rolled steel, which is conducted anyway in the context of production of packaging steel, for example, during melting of a tin layer applied electrolytically to the surface of the steel sheet or during firing of a coating layer applied to the steel sheet surface.

Because of the upper limit proposed in EP 0 216 399 B1 for the amount of unbonded nitrogen dissolved in the steel of 100 ppm, the strengths of this known packaging steel are limited. It appears to be possible, in principle, to produce steel sheets with an even higher content of unbonded nitrogen in the steel in order to achieve tensile strengths above 600 MPa. For example, nitrided steels with a nitrogen content of up to 250 ppm and up to 400 ppm are described in EP 1 342 798 B1 and DE 1 433 690 A1. However, such high unbonded nitrogen contents in the steel have not been attainable in practice.

The nitriding of a steel can be introduced in the steel production process by incorporating nitrogen in the steel melt, for example, by blowing in nitrogen gas N₂. A method for the nitriding of steel melts in steel production in the basic oxygen steel-making process is described, for example, in DE 2 237 498. Flat steel products, especially steel strips, can be nitrided by surface conditioning, for example, by diffusion of nitrogen into the steel sheet surface, which can occur, for example, by gas nitriding in an ammonia atmosphere at slight overpressure, by bath nitriding in nitrogen-containing salt baths or by plasma nitriding. A hard, surface bonding layer and an underlying diffusion zone in which nitrogen is incorporated in the (ferritic) steel matrix to a certain depth is formed on the steel sheet surface by the diffusion of nitrogen.

### SUMMARY

One aspect of the invention relates to a flat steel product (steel sheet or steel strip) for production of packaging, which has the highest possible strength with good elongation at break and good deformation properties at the same time. A packaging steel with strengths of at least 600 MPa at an elongation at break of at least 5% is another aspect of the invention. The packaging steel of higher strength must then simultaneously have sufficient deformability for the proposed application as packaging steel, for example, in the deep drawing or ironing process, so that the intended packages can be produced from the flat steel product, for example, food or beverage cans. The packaging steel present as flat steel product should then have the usual thicknesses in the fine and ultrafine sheet range, which ordinarily lie in the range of 0.1 to 0.5 mm (ultrafine sheet) or 0.5 to 3 mm (fine sheet) and are produced by cold rolling.

Preferred variants of the method according to the invention and the packaging steel are also disclosed.

A nitrided packaging steel with a carbon content from 400 to 1200 ppm and an amount of unbonded nitrogen dissolved in the steel of more than 100 ppm and preferably more than 150 ppm and especially more than 210 ppm can be produced with the method according to the invention, in which case a hot-rolled and optionally already nitrided steel product is initially cold-rolled to a flat steel product, the cold-rolled flat steel product is then subjected to recrystallization annealing in an annealing furnace, in which case a nitrogen-containing gas is introduced into the annealing furnace and directed onto the flat steel surface in order to introduce unbonded nitrogen into the flat steel product in an amount corresponding to a concentration of more than 100 ppm, or to increase the amount of unbonded nitrogen in the flat steel product to a concentration of more than 100 ppm. Directly after annealing, this flat steel product is cooled at a cooling rate of at least 100 K/s. On the one hand, a multiphase structure is formed in this process in the flat steel product, which includes ferrite and at least one of the structural components martensite, bainite, troostite/perlite and/or residual austenite. Steel products with such a structure have increased strength relative to monophase steels. On the other hand, the nitrogen content in the steel is increased to value ranges (of more than 100 ppm) that cause a strength increase by nitriding of the flat steel product during recrystallization annealing.

It has been shown that the carbon content of the steel must be at least 0.04 wt % for the formation of a multiphase structure. The upper limit of the carbon content, is stipulated by the upper limits required by the standards for packaging steel of about 0.12 wt % (as defined in ASTM standard A623-11) and, on the other hand, technologically, by the cold rolling capability, in which, according to experience, a hot-rolled steel product with more than 0.12 wt % carbon content can only be cold rolled with considerably difficulty.

The nitriding of the steel can then expediently occur in two stages. In a first stage, a steel melt is nitrided to a nitrogen content of 160 ppm maximum by supplying nitrogen to the steel melt, for example, in the form of a nitrogen-containing gas and/or nitrogen-containing solid. A slab is cast from the steel melt so nitrided and hot rolled to a hot strip. The hot strip is then pickled, if required (after cooling to ambient temperature), and cold rolled to a flat steel product (steel sheet or steel strip). The cold-rolled flat steel product is then recrystallization annealed in the annealing furnace. The second stage of nitriding is then conducted in the annealing furnace by introducing a nitrogen-containing gas into the annealing furnace and directing it at the flat steel product in order to further increase the amount of unbonded nitrogen in the steel above the nitrogen amount already introduced into the steel melt in the first stage of nitriding.

Two-stage annealing of the packaging steel ensures that the hot strip can be cold-rolled without problem to a flat steel product, especially a steel strip with the cold-rolling equipment (roll trains) ordinarily used for the production of packaging steels. This is made possible by the fact that an unbonded nitrogen content of at most 160 ppm is introduced into the steel melt during the first stage of nitriding. The hot strip produced by hot rolling from the nitrided steel melt remains cold rollable at these nitrogen contents so that a fine or ultrafine sheet can be produced by cold rolling from the hot strip in the usual thicknesses for packaging purposes. Higher nitrogen contents in the steel melt also lead to undesired defects in the slab cast from the steel melt. The desired strength of the packaging steel of preferably more than 600 MPa is achieved during cold rolling and in the second stage of nitriding of the flat steel product during recrystallization annealing. Flat steel product, especially steel strips, with thicknesses in the fine and ultrafine sheet range, especially in the range of 0.1 to 0.5 mm, can thus be produced for use as packaging steel with very high tensile strength and high elongation at break of preferably at least 5% at the same time without suffering a limitation in deformation properties.

In preferred embodiment examples of the method according to the invention, the nitriding of the steel melt in the first stage occurs by introducing nitrogen gas (N₂) and/or calcium cyanamide (CaCN₂) and/or manganese nitride (MnN) into the steel melt.

The nitriding of the flat steel product in the second stage preferably occurs by introducing ammonia gas (NH₃) to the annealing furnace, in which this flat steel product is recrystallization annealed. The ammonia gas is then expediently applied by spray nozzles onto the surface of the flat steel product. The amount of ammonia gas introduced into the annealing furnace is preferably adjusted so that ammonia equilibrium with an ammonia concentration in the range of 0.05 to 15% is set in the annealing furnace (in wt %, relative to the gas atmosphere in the annealing furnace). The ammonia concentration in the annealing furnace required for effective nitriding then depends on the temperature in the annealing furnace. At ideal temperatures in the range of 600 to 650° C., an ammonia concentration in the range of 0.05 to 1.5 wt % is already sufficient to incorporate the desired amounts of unbonded nitrogen (interstitial nitrogen) in the flat steel product during nitriding. At higher temperatures, especially above 700° C., the ammonia concentration in the annealing furnace must be chosen correspondingly higher (up to 15 wt %) in order to incorporate nitrogen in the flat steel product in worthwhile amounts. The ammonia concentration in the annealing furnace is preferably detected by an ammonia sensor and the detected measured value of ammonia equilibrium concentration is used for control of the amount of ammonia gas introduced per unit time to the annealing furnace. An equal ammonia gas concentration in the annealing furnace can therefore be ensured and thus homogeneous nitriding of a flat steel product with equivalent quality over the production time of a steel strip and homogeneous nitrogen concentration over the length of the steel strip.

To avoid oxidation processes an inert gas is introduced into the annealing furnace, for example, nitrogen gas and/or hydrogen gas or a mixture thereof during recrystallization annealing in the annealing furnace, in addition to the ammonia gas used for nitriding, for example, in a composition of 95 wt % nitrogen gas and 5 wt % hydrogen gas. The annealing furnace thus also acts as a sealed inert chamber. The steel strip passed through the annealing phase therefore does not come into contact with an oxidizing environment and especially atmospheric oxygen during recrystallization annealing and nitriding up to cooling, for which reason the formation of oxide layers on the surface of the steel strip can be avoided.

The total amounts of unbonded nitrogen introduced by two-stage nitriding of packaging steel lie between 100 and 500 ppm, preferably above 150 ppm and especially lying between 210 and 350 ppm. During two-stage nitriding, a nitrogen content of maximum 160 ppm is introduced into the steel melt in the first stage during the nitriding of the steel melt. Maintaining an upper limit of about 160 ppm for the content of unbonded nitrogen in the steel melt ensures that no defects are formed on the slab produced from the steel melt, for example, in the form of pores and cracks, which can oxidize from surrounding oxygen. The hot strip produced from the slab also remains cold-rollable at a nitrogen content of at most 160 ppm. Alternatively, nitriding can also occur in one stage, in which case the nitriding of the cold-rolled flat steel product only occurs by exposure to a nitrogen-containing gas in the continuous furnace during recrystallization annealing.

The amount of unbonded nitrogen that can be incorporated (optionally, as a second stage) during the nitriding of the flat steel product in the annealing furnace by exposure to a nitrogen-containing gas (optionally, additionally) lies in the range of 100 to 350 ppm. When both nitriding stages are used, the total amount of unbonded nitrogen in the packaging steel produced according to the invention is preferably more than 150 ppm, and especially more than 210 ppm, and up to 500 ppm can therefore be introduced. Tensile strengths of more than 650 MPa and up to 1000 MPa can thereby be achieved, in which a linear relation between the content of unbonded nitrogen and tensile strength has been established and tensile strengths of about 650 MPa, for example, require an unbonded nitrogen content of about 210 ppm.

The multiphase structure of the steel produced by the heat treatment according to the invention contributes to an increase in strength of the cold-rolled flat steel product in addition to nitriding. To form a multiphase structure, the cold-rolled flat steel product during recrystallization annealing is heated in a heating step to temperature above the Ac1 temperature (which generally lies at about 723° C. at the employed alloy composition of the steel). It has been shown that the flat steel product must be heated at least briefly to a temperature above the Ac1 temperature in order to form a multiphase structure. Heating can then occur either by thermal radiation in the annealing furnace or also inductively or conductively, in which very high heating rates of more than 500 K/s can be achieved by inductive or conductive heating. During its heating, the cold-rolled flat steel product is held for a sufficiently long heating time at temperatures above the recrystallization temperature in order to recrystallization anneal the flat steel product so that the deformability of the cold-rolled flat steel product is restored. After (at least brief) heating to a temperature above the Ac1 temperature, the flat steel product is quickly cooled, wherein a cooling rate of least 100 K/s and preferably more than 150 K/s should be maintained in order to form a multiphase structure in the steel.

In order to ensure optimal thermal conditions in the annealing furnace both for recrystallization annealing and formation of a multiphase structure and for nitriding, the flat steel product is expediently subjected in the annealing furnace to an annealing cycle with stipulated temperature profiles. In a first embodiment example for such an annealing cycle the cold-rolled flat steel product is heated in a continuous annealing furnace (by thermal radiation) in a first heating step initially from ambient temperature at a heating rate of expediently 15 to 25 K/s and especially 20 K/s to a holding temperature above the recrystallization temperature but still below the Ac1 temperature and especially in the range of 600 to 650° C., and then held at this holding temperature (Tₕ) over a holding period. During the holding period, which expediently lies in the range of 80 to 150 seconds and, for example, at about 100 to 110 seconds, the flat steel product is exposed to nitriding with the nitrogen-containing gas at the holding temperature (Tₕ). The holding temperature (Tₕ) is then expediently chosen so that the most efficient incorporation of nitrogen in the flat steel product possible can be ensured. It has been shown that this is the case especially in the temperature range between 600 and 650° C. The ammonia concentration in the annealing furnace can then be set at low values in the range of 0.05 to 1.5 wt %.

Immediately after nitriding in the annealing furnace, the flat steel product is heated in a second heating step to an annealing temperature (T_{g}) above the Ac1 temperature, and preferably between 740° C.≦T_{g}≦760° C., and then cooled at a cooling rate of more than 100 K/s. The heating rate in the second heating step is then preferably more than 100 K/s and especially more than 500 K/s, wherein heating expediently occurs inductively or conductively in the second heating step to achieve such high heating rates. Heating rates of more than 1000 K/s can be achieved by inductive or conductive heating.

Cooling at the preferred cooling rate of more than 100 K/s can occur either by means of a cold gas stream (preferably an inert gas, like hydrogen or nitrogen) or by introduction of the flat steel product to a quenching liquid (for example, a water tank), in which case the flat steel product is preferably cooled to ambient temperature.

In a second embodiment example for an annealing cycle, the cold-rolled flat steel product is initially heated in a continuous annealing furnace (by thermal radiation) in a (single) heating step initially from ambient temperature at a heating rate of expediently more than 15 K/s to a holding temperature (Tₕ) above the Ac1 temperature, and especially in the range of 740° C. to 760° C., and held in a subsequent holding step for a holding time at this holding temperature (Tₕ), wherein the cold-rolled flat steel product is exposed to nitriding with the nitrogen-containing gas during the heating step and/or during the holding step. The flat steel product during the heating step is preferably exposed to the nitrogen-containing gas, since it has been shown that nitriding is most efficient at temperatures below about 700° C., and especially in the temperature range from 600 to 660° C. The holding time, during which the flat steel product is held at temperatures above the Ac1 temperature, then expediently lies in the range of 80 to 150 seconds and, for example, at about 100-110 seconds.

A variety of spray nozzles are used for nitriding with a flat steel product in the annealing furnace, with which a nitrogen-containing gas, like ammonia gas, can be uniformly applied to the surface of the flat steel product passing through the annealing furnace. During production of a steel strip, which is passed through the annealing furnace at a strip speed of at least 200 m/min, the several spray nozzles are arranged across the running direction of the strip and preferably equidistant from each other. Homogeneous nitriding with a flat steel product over the entire surface is thereby possible.

By recording the concentration of nitrogen-containing gas introduced into the annealing furnace, it can be ensured that during passage of the steel strip through the annealing furnace an identical nitrogen atmosphere is maintained in the annealing furnace. This permits homogeneous nitriding of the steel strip over its length.

It can be established by comparative experiments that by nitriding of the packaging steel produced according to the invention, not only can its strength be increased, but also improved deformability is additionally observed because of the higher content of unbonded nitrogen in the steel. This is found in particular in packaging steels produced according to the invention that are coated with a varnish. In conventional varnish-coated packaging steels, an abrupt reduction of elongation at break of the flat steel product at higher strength is observed after heat treatment required for baking during coating. This phenomenon is not to be observed in the nitrided flat steel products produced according to the invention. In this case, even at very high strengths of more than 650 MPa, no reduction of elongation at break is observed after heat treatment during coating (bake hardening). This might be explainable by the fact that the high content of unbonded nitrogen present because of the two-stage nitriding and the very homogeneous distribution of nitrogen in the steel blocks any dislocations that are present and these dislocations blocked by free nitrogen atoms are suddenly dissolved in large numbers during deformation of the flat steel product as soon as an applied tensile stress is increased beyond a limit value. Because of this, the numerous dislocations released by deformation from nitrogen blocking migrate in the steel so that deformability is improved.

### BRIEF DESCRIPTION OF THE DRAWINGS

These and additional advantages of the packaging steel produced according to the invention are apparent from the following embodiment example described with reference to the accompanying drawings. The drawings show:

FIG. 1: schematic depiction of a first embodiment example of an annealing furnace, in which nitriding and recrystallization annealing of a flat steel product is conducted according to the method of the invention;

FIG. 2: schematic depiction of a second embodiment example of an annealing furnace, in which nitriding and recrystallization annealing of a flat steel product is conducted according to the method of the invention;

FIGS. 3a to 3c: graphic depiction of the temporal temperature profile of the annealing cycles conducted in the annealing furnace of FIG. 1 during performant of the method of the invention.

### DETAILED DESCRIPTION

In a first embodiment example of the method according to the invention, a steel product produced and hot rolled in continuous casting with a thickness in the range of 2 to 15 mm thickness and a carbon content of 400 to 1200 ppm is used as starting product. The alloy composition of the steel then expediently fulfills the limit values stipulated by standards for packaging steel (as defined, for example, in ASTM standard A623-11 “Standard Specification for Tin Mill Products” or in European standard EN 10202). The steel product used as starting product preferably has the following upper limits for the weight fraction of alloy components (in order to make the end product consistent with the cited standards for packaging steel):
C: max. 0.12%,
Mn: max. 0.4%,
Si: max. 0.04%, preferably less than 0.02%;
Al: max. 0.1%, preferably less than 0.08%;
Cr: max. 0.1%, preferably less than 0.08%;
P: max. 0.03%, preferably less than 0.02%;
Cu: max. 0.1%, preferably less than 0.08%;
Ni: max. 0.15%, preferably less than 0.08%;
Sn: max. 0.04%, preferably less than 0.02%;
As: max. 0.02%,
S: max. 0.03%, preferably less than 0.02%;
Mo: max. 0.05%, preferably less than 0.02%;
V: max. 0.04%;
Ti: max. 0.05%, preferably less than 0.02%;
Nb: max. 0.05%, preferably less than 0.02%;
B: max. 0.005%;
other alloy components, including impurities: max. 0.05%;
remainder iron.

A steel product with such an alloy composition is cold rolled in the method according to the invention initially with a thickness reduction from 50% to 96% to a final thickness in the fine or ultrafine sheet range (about 0.1 to 0.5 mm) to a flat steel product (steel sheet or steel strip). The steel product is expediently rolled to a steel strip and wound as a coil. According to the invention, the flat steel product is then introduced into an annealing furnace for recrystallization annealing, on the one hand, and nitriding, on the other, to nitrogen concentrations of more than 100 ppm, and preferably more than 210 ppm. Immediately after recrystallization annealing, the flat steel product is cooled according to the invention at a cooling rate of at least 100 K/s expediently to room temperature.

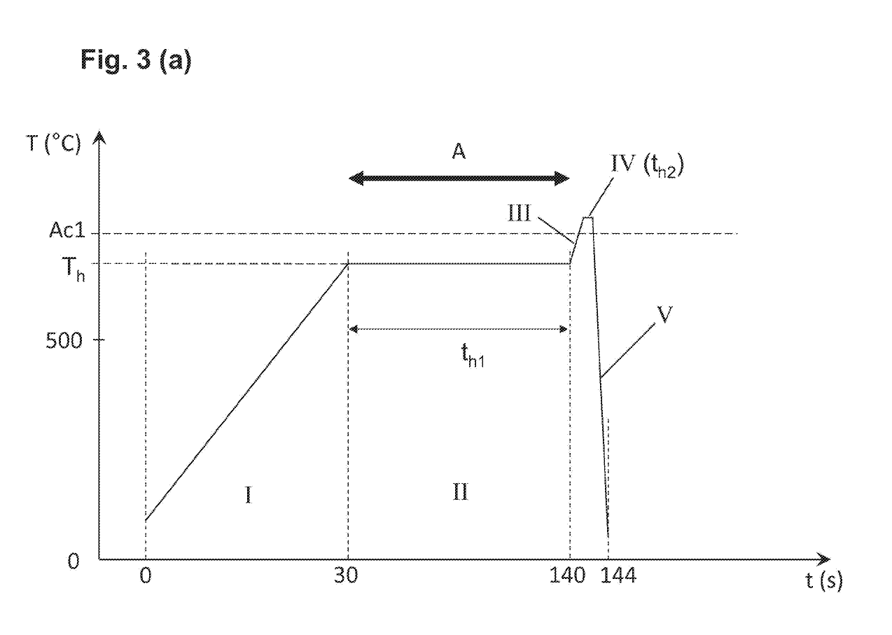

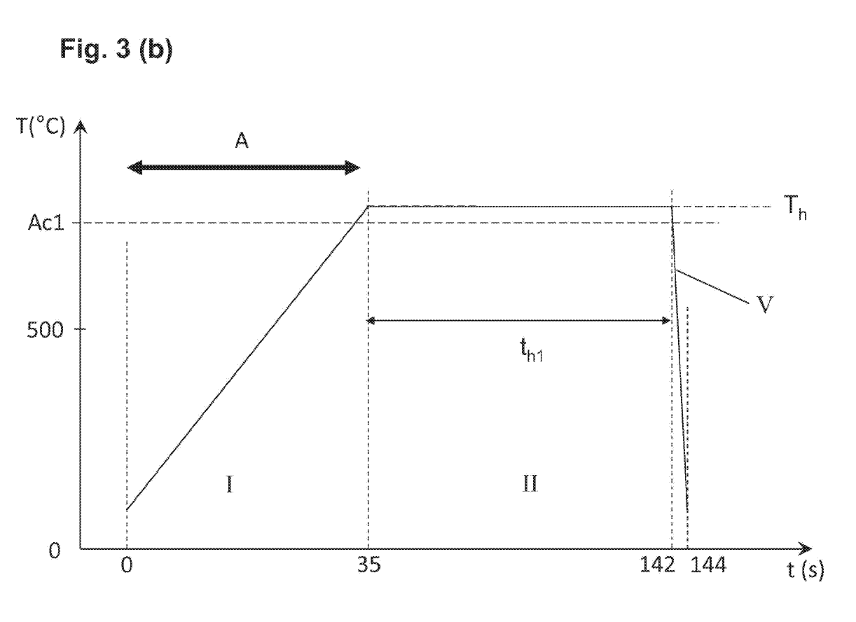

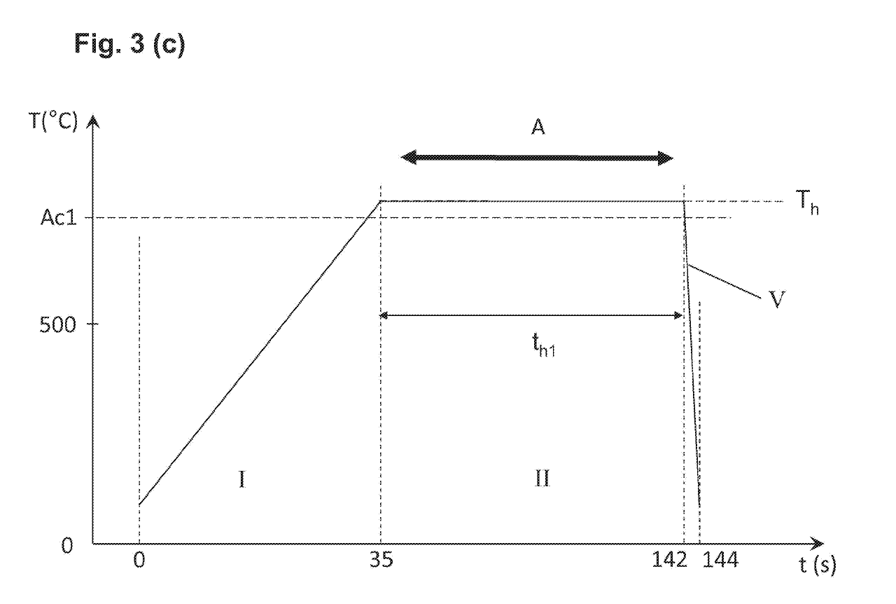

To restore the crystal structure of the steel destroyed during cold rolling of the steel product, the cold-rolled steel strip must be recrystallization annealed. This occurs according to the invention by passing the cold-rolled steel strip through an annealing furnace, which is expediently designed as a continuous annealing furnace through which the flat steel product expediently present as a steel strip is passed with a speed of more than 200 m/min. The flat steel product subsequently referred to as steel strip is heated in the annealing furnace to temperatures above the recrystallization point of steel and at least briefly above the Ac1 temperature. Nitriding of the steel strip occurs in the method according to the invention simultaneously with recrystallization annealing. This is also conducted in the annealing furnace by introducing a nitrogen-containing gas, preferably ammonia (NH₃), to the annealing furnace and passing it to the surface of the steel strip. In order to create optimal (temperature) conditions in the annealing furnace for both recrystallization annealing and nitriding, the steel strip is subjected in the annealing furnace to an annealing cycle (annealing process with a temperature trend of the steel strip alternating with time). Preferred annealing cycles are explained below with reference to FIG. 3:

A first embodiment example for an appropriate annealing cycle in the form of the time profile of the temperature (T) of the steel strip passed through the annealing furnace is shown in FIG. 3(a). The steel strip is heated in this annealing cycle in the annealing furnace initially in a first heating step I from room temperature to a holding temperature (Tₕ). Heating of the steel strip in the first heating step then occurs by thermal radiation in the heated annealing furnace with a (comparatively limited) heating rate of 15 to 25 K/s, and especially about 20 K/s. The holding temperature (Tₕ) then expediently lies just above the recrystallization temperature of steel and preferably in the range of 600 to 650° C. The temperature of the steel strip is held in a holding step II following the first heating step I after the holding temperature (Tₕ) for a first holding time (tₕ₁) of about 60 to 200 seconds, and preferably about 80 to 150 seconds, especially about 100 to 110 seconds. During the holding step II, the steel strip is exposed in a nitriding phase A, preferably over the entire holding time (tₕ₁), to a nitrogen-containing gas in order to nitride the steel strip (i.e., to increase the concentration of unbonded nitrogen in the steel to values above 100 ppm and preferably more than 210 ppm). After completion of the first holding time (tₕ₁), the steel strip is heated in a second (short) heating step III very quickly (preferably within a short heating time between 0.1 s and 10) at a heating rate of more than 100 K/s and preferably more than 500 K/s to a temperature above the Ac1 temperature of steel, especially to temperatures in the range of 725 to 800° C. The second heating step III is then conducted in the annealing furnace for inductive or conductive heating of the steel strip. For this purpose, induction or conduction heating is arranged within the annealing furnace through which the steel strip is passed in the second heating step III. A short second holding step IV follows the second heating step III, in which the steel strip is passed through induction or conduction heating and its temperature is held for a (short) second holding time (tₕ₂), which lies in the range of a few seconds (between 0.1 and 10 seconds and especially about 2 seconds), above the Ac1 temperature.

After annealing, the steel strip is removed from the annealing furnace and cooled in a cooling step V outside the annealing furnace at a cooling rate of at least 100 K/s to room temperature. The cooling step V is then immediately followed by the (short) second holding time (tₕ₂). Cooling can then occur by means of a cold gas stream, which is directed at the surface of the steel strip, or by introducing the steel strip into a cooling liquid, for example, into a water bath. When a cooling liquid is used, higher cooling rates in the range much greater than 1000 K/s can be achieved. Quenching of the steel strip with a cooling liquid, however, is more demanding in terms of equipment.

The at least brief heating of the flat steel product at temperatures above the Ac1 temperature (about 723° C.) ensures the entry of the steel during the annealing cycle of FIG. 3(a) into the two-phase region (alpha- and gamma-iron), which again permits formation of a multiphase structure during subsequent (rapid) cooling. At the same time, nitriding can be conducted in this annealing cycle during the first holding step II at much lower temperatures (in the range of 600 to 650° C.), which makes possible higher efficiency of nitriding and lower consumption of nitrogen-containing gas.

Two additional embodiment examples for appropriate annealing cycle are shown in FIGS. 3(b) and 3(c). In these annealing cycles, the steep strip is heated in the annealing furnace initially in a (single) heating step I from room temperature to a holding temperature (Tₕ), in which the holding temperature (Tₕ)—unlike in the first embodiment example of FIG. 3(a)—then lies above the Ac1 temperature of the steel and preferably is in the range 740 to 800° C. Heating of the steel strip in the (single) step I then occurs again by thermal radiation in the heated annealing furnace with a (comparatively limited) heating rate from 15 to 25 K/s and especially about 20 K/s. The temperature of the steel strip is held in a holding step II following the (single) heating step I at the holding temperature (Tₕ>Ac1) for a holding time (tₕ₁) from about 60 to 200 seconds and preferably 80 to 150 seconds. The steel strip—as in the embodiment example of FIG. 3(a)—is then cooled in the annealing furnace in a cooling step V at a cooling rate of at least 100 K/s to room temperature. The cooling step V then immediately follows the holding step II.

The steel strip is already exposed in the annealing cycle according to FIG. 3(b) to a nitrogen-containing gas during the (single) heating step I. The nitriding phase A in this annealing cycle therefore coincides with heating of the steel strip in the (single) heating step I. The steel strip is preferably exposed at least essentially over the entire heating time of the heating step I to a nitrogen-containing gas in order to nitride the steel strip.

In contrast to this, the steel strip in the annealing cycle according to FIG. 3(c) is only exposed to a nitrogen-containing gas during the holding step II. The nitriding phase A in this annealing cycle therefore coincides with the holding step II.

It has been shown that it is advantageous to hold the steel strip following gassing with a nitrogen-containing gas (for example, NH₃ treatment) over a holding time of preferably more than 5 seconds at temperatures above 600° C. before it is cooled. Homogenization of nitrogen distribution over the cross section of the steel strip thereby occurs and improved deformation properties of the steel strip. In particular, a reduction in elongation during bake hardening can also be avoided. The annealing cycles according to FIGS. 3(a) and 3(b) are therefore preferred, and in the annealing cycle according to FIG. 3(c) the nitriding phase is expediently ended before the end of the holding time.

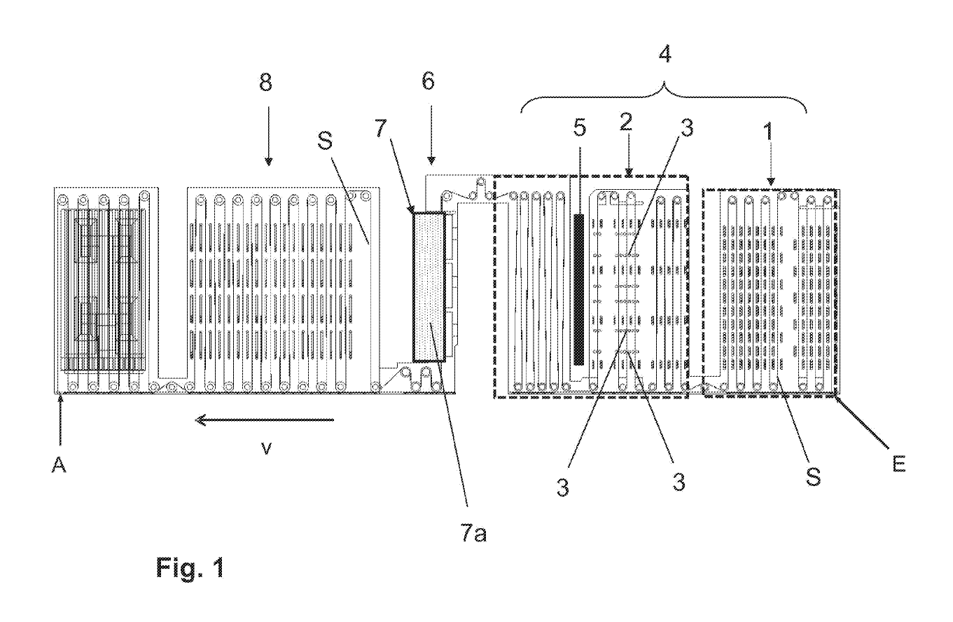

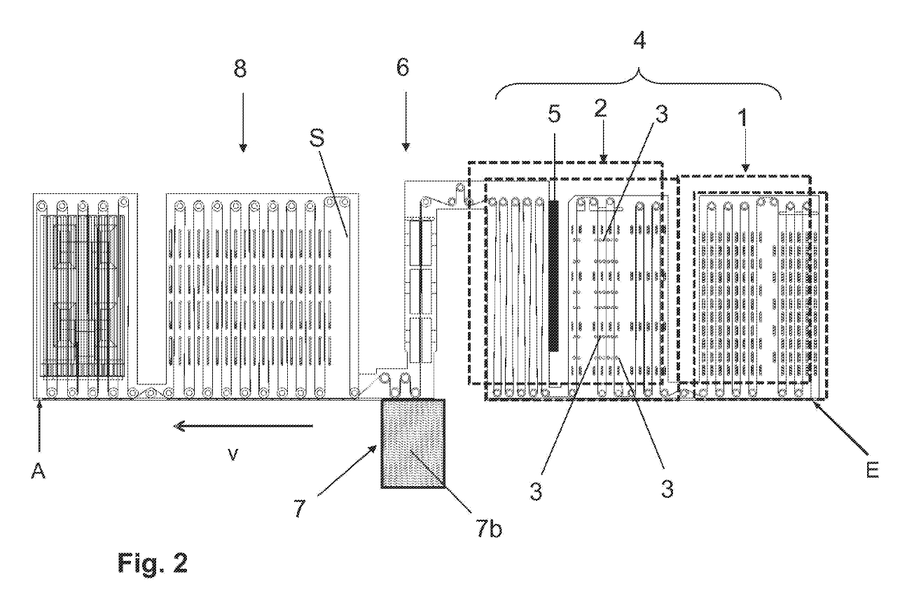

Two embodiment examples of a continuous annealing furnace for performing recrystallization annealing and nitriding are schematically shown in FIGS. 1 and 2, which differ from each other (only) by the design of the cooling device. Different zones are formed in the continuous annealing furnace between an inlet E and an outlet A, which are arranged one behind another in the passage direction (strip passage direction v in FIG. 1 from right to left) of the steel strip S passed through the continuous annealing furnace. The continuous steel strip S is brought to different temperatures in the individual zones in order to pass through the annealing cycles described above.

In the embodiment examples of FIGS. 1 and 2, a heating zone 1 follows the inlet E of the continuous annealing furnace, in which the steel strip S is heated at least in the front region (only) by thermal radiation at a heating rate of up to 25 K/s and, depending on the selected annealing cycle, to temperatures just below or just above the Ac1 temperature and especially in the range of 600 to 800° C. Heating zone 1 is followed by a holding zone 2, in which the temperature of the steel strip S is held at the holding temperature (Tₕ), which lies below or above the Ac1 temperature, depending on the selected annealing cycle.

A gassing zone 4 is formed in holding zone 2, in which a continuous steel strip is exposed to a nitrogen-containing gas. The gassing zone 4 has several cascades 3 of spray nozzles, which are arranged one behind another in the moving direction of the strip. In the embodiment example of FIG. 1, the spray nozzle cascades 3 are arranged (only) in the area of the holding zone 2. However, they can also be arranged in the area of heating zone 1, so that gassing zone 4 extends either only in heating zone 1 or over heating zone 1 and holding zone 2. For performing the annealing cycle according to FIG. 3(b) the spray nozzle cascades 3 are expediently arranged in the heating zone 1. For performance of the annealing cycle according to FIGS. 3(a) and 3(c), the spray nozzle cascades 3 are expediently arranged in holding zone 2. For performance of the annealing cycle according to FIG. 3(a), induction or conduction heating 5 is additionally arranged in the downstream area of holding zone 2.

Each spray nozzle cascade 3 then includes a number of nozzles that are arranged at a spacing relative to each other across the running direction of the strip. The nozzles are connected to a gas supply line, via which they are exposed to a nitrogen-containing gas. Ammonia gas has proven to be particularly suitable for the nitriding of steel strips. This is applied via the nozzles of cascades 3 onto the surface of the continuous steel strip S, where it penetrates the near-surface region of the steel strip and diffuses uniformly into the steel strip at the high temperatures of the annealing furnace. A uniformly homogeneous nitrogen distribution is therefore formed over the thickness of the steel strip, whose concentration distribution over the sheet thickness in steel sheets with a thickness of less than 0.4 mm deviates by at most ±10 ppm and regularly by only ±5 ppm about the mean value.

The design of the preferred nozzles of the spray nozzle cascades 3 is described in German patent application DE 102014106135 of Apr. 30, 2014, whose disclosure content is hereby incorporated by reference. A nozzle device for treatment of a flat steel product is described in this patent application, in which the nozzle device includes an outer tube and inner tube arranged therein with a primary opening to supply a gas flowing through the nozzle device into the outer tube, and the outer tube is provided with a secondary opening through which the gas can emerge. The primary opening of the inner tube and the secondary opening of the outer tube are then arranged offset relative to each other. A very homogeneous gas flow onto the surface of the flat steel product is thereby made possible. When this type of nozzle device is used in the method according to the invention, homogeneous gassing of the surface of the steel strip in a continuous annealing furnace can be achieved with the nitrogen-containing gas (for example, ammonia), so that homogeneous diffusion of nitrogen into the steel sheet can be achieved over the surface of the steel strip, especially over its width, and the nitrogen is added there interstitially.

The method of direct exposure of the steel strip (gassing) to a nitrogen-containing gas by means of nozzles then has two essential advantages: in the first place, only a limited nitrogen concentration (NH₃ concentration) is required, which leads to limited consumption of nitrogen-containing gas (for example, NH₃ consumption). In the second place, formation of a nitride layer does not occur because of a very short exposure time.

In order to also ensure the most homogeneous formation possible of a nitrogen-enriched surface layer of the length of the steel strip S, during passage of the steel strip S through the gassing zone 4 of the continuous annealing furnace, a nitrogen-containing atmosphere must be maintained with the most uniform nitrogen equilibrium concentration possible. In order to ensure this, the nitrogen concentration formed in the area of the spray nozzle cascades 3 is recorded. When ammonia is used as nitrogen-containing gas, the ammonia concentration generated by the introduction of ammonia is measured for this purpose in the gassing zone 4. For this purpose, a concentration sensor arranged outside the continuous annealing furnace is provided, which can be a laser spectroscopy sensor. A gas sample taken from the gassing zone 4 is fed to it in order to determine the ammonia concentration and the nitrogen concentration of the gas atmosphere in the gassing zone. The concentration of nitrogen in the gas atmosphere of the gassing zone 4 recorded by the concentration sensor is fed to a control device and used by it in order to keep the amount of nitrogen-containing gas (ammonia) sprayed into the gassing zone 4 via the nozzles of cascades 3 constant at a stipulated target value.

Target values for the equilibrium concentration of ammonia in the range of 0.05 to 1.5% and preferably below 1%, especially below 0.2%, have proven particularly expedient when ammonia is used as nitrogen-containing gas. The equilibrium concentration of ammonia preferably lies in the range of 0.1 to 1.0% and especially between 0.1 and 0.2%. These low ammonia or nitrogen concentrations in the annealing furnace are sufficient in order to introduce the desired amounts of nitrogen into the flat steel product during nitriding at temperatures in the range of 600 to 650° C. At higher temperatures, especially above 700° C., as occur during nitriding in the annealing cycle of FIG. 3(c), higher ammonia concentrations must then be generated in the annealing furnace of up to 15 wt % in order to achieve the desired amount of nitriding.

To avoid oxidation processes on the surface of the steel strip S, an inert gas is introduced into the annealing furnace in the gassing zone 4, in addition to the nitrogen-containing gas (ammonia). This can be nitrogen gas or/or [sic; and/or] hydrogen gas. A mixture of about 95% nitrogen and about 5% hydrogen gas is preferably used.

A first cooling zone is provided in the strip running direction v after holding zone 2 (and optionally after the induction or conduction heating 5 arranged at the end of holding zone 2), in which the continuous steel strip S is rapidly cooled at a cooling rate of at least 100 K/s. The first cooling zone 6 contains a cooling device 7, which is designed in the embodiment example of FIG. 1 as a gas cooling device 7a, in which the steel strip is exposed to a cold gas stream, especially an inert gas. In the embodiment example of FIG. 2, the cooling device 7 is designed as a liquid cooling device, in which the steel strip is quenched by introduction into a cooling liquid, especially a water bath 7b. Cooling rates in the range of 100 to 1000 K/s can be achieved with the gas cooling device. Much higher cooling rates (far above 1000 K/s) are attainable with the liquid cooling device. In the cooling device 7, which is arranged in the inert atmosphere of the annealing furnace, the steel strip S is initially rapidly cooled to a temperature that is above room temperature, for example, to temperature of around 100° C. A second cooling zone 8 expediently follows the first cooling zone 6 downstream, in which the continuous steel strip S is finally slowly cooled to room temperature (23° C.) at a cooling rate in the range of 10 to 20 K/s. The steel strip S is then removed from the annealing furnace at outlet A. The steel strip S between inlet E and outlet A is continuously found in the inert atmosphere of the annealing furnace, so that oxidation processes cannot occur on the surface of steel strip S during recrystallization annealing, nitriding and cooling.

After cooling, the steel strip S, if necessary, can be temper-rolled dry (dressed) in order to impart to the strip the deformation properties required for production of packaging. The degree of temper rolling then varies between 0.4 and 2%, depending on the application of the packaging steel. If necessary, the steel strip can also be temper-rolled wet, in order to generate a further thickness reduction of up to 43% (double-reduced steel strip). An additional increase in strength occurs during temper rolling. The steel strip S is then optionally fed to a coating unit, in which the surface of the steel strip is provided, for example, electrolytically with a tin or chromium/chromium dioxide coating (ECCS) or varnishing to increase corrosion resistance. During coating of the surface of the packaging steel, baking of the coating ordinarily occurs by heating the coated packaging steel, in which case an additional strength increase known as “bake hardening” is observed by this baking process. It has been found that packing steels produced with the method according to the invention not only have higher strengths, but also better properties in terms of corrosion resistance than the known flat steel products.

Heat treatment in the annealing furnace according to the invention leads to the formation of a multiphase structure in the steel of the cold-rolled flat steel product. The structural composition can then be controlled via the process parameters. It was found that during annealing of the flat steel product (steel strip S) above the Ac1 temperature and subsequent rapid cooling (quenching) at a cooling rate in the range of 100 K/s to about 1000 K/s, a multiphase structure consisting of ferrite and troostite (finely striated perlite) is formed. If the flat steel product is annealed above the Ac1 temperature and then quenched at a very high cooling rate of (much) more than 1000 K/s (for example, by introduction into a cooling liquid, especially a water bath 7b, as shown in FIG. 2), on the other hand, a structure with ferrite and martensite is formed as essential structure components, which largely corresponds to the dual-phase structure known from auto body design. Both the multiphase structure from ferrite and troostite and the multiphase structure from ferrite and martensite are characterized by increased strength relative to the monophase steel structure. The high strength of the packaging steel produced according to the invention is therefore achieved, on the one hand, by the strength-increasing content of unbonded nitrogen incorporated interstitially by nitriding and, on the other hand, by the formation of a multiphase structure during heat treatment in an annealing furnace.

Nitrided flat steel products characterized by very high strength of more than 650 MPa with simultaneously good elongation at break of more than 5% and especially between 7 and 15% as well as good deformation properties can be produced with the method according to the invention. The strength values of the packaging steel produced according to the invention are optionally further increased in a firing process of an applied coating layer (yield point increase by bake hardening), in which strengths of up to 850 MPa are obtainable.

The strength and elongation at break increased by nitriding are then very homogeneous over the cross section of the steel strip both in and across the rolling direction of the cold-rolled steel strip. This results from very homogeneous introduction of unbonded nitrogen into the steel during nitriding in the annealing phase. Melt analyses on flat steel products produced according to the invention have shown that the nitrogen concentration introduced by nitriding over the thickness of the flat steel product, in each case in ultrafine sheets, only deviates over a narrow band of at most ±10 ppm and regularly only around ±5 ppm about the mean concentration.

The hot-rolled steel product, which is used as starting product of the method according to the invention, can already contain a fraction of nitrogen. The following method is conducted to produce a corresponding starting product (as expanded embodiment example of the invention):

A nitrided steel melt is initially generated in a converter and/or in a subsequent ladle treatment, which has a content of free, unbonded (i.e., dissolved in steel) nitrogen of up to 160 ppm. The alloy composition of the produced steel then expediently satisfies the limit valued stipulated by standards for packaging steel (like ASTM standard A623-11 “Standard Specification for Tin Mill Products” or as defined in European standard EN 10202), except for the upper limit for nitrogen content (which lies at Nₘₐₓ=80 ppm in standard EN 10202 and at Nₘₐₓ=200 ppm in the AST ASTM standard 623), which can be surpassed owing to nitriding in the method according to the invention. The carbon fraction of the produced steel then preferably lies in the range of 400 to 1200 ppm and especially between 600 and 900 ppm.

To produce the steel melt, the converter is filled with scrap and crude iron and the melt blown with oxygen gas and nitrogen gas, in which case the oxygen gas (O₂) is blown from above and the nitrogen gas (N₂) by means of bottom nozzles from below into the converter. A nitrogen content in the steel melt from 70 to 120 ppm is thus established, in which case saturation occurs. During production of the steel melt the composition and especially the nitrogen content of the melt are recorded. If the stipulated analysis is not correct (if the percentage of phosphorus is too high) oxygen gas is blown in through an oxygen lance and argon gas (Ar) through the bottom nozzles. Since virtually no more carbon (C) is present in the steel, no overpressure is formed and the nitrogen of the air is drawn in so that additional nitriding can occur.

If the desired amount of (dissolved) nitrogen in the steel melt (which regularly lies at about 120 ppm) is still not achieved by blowing in of nitrogen gas, during emptying of the converter (tapping) calcium cyanamide (CaCN₂) can additionally be introduced into the steel stream emerging from the converter. The calcium cyanamide is then added in the form of a granulate (5-20 mm).

The ladle then goes to first argon scavenging, where it is scavenged with argon for about 3 minutes with an introduced refractory lance. After control analysis, if necessary, a second argon scavenging occurs for about 3 minutes. The ladle then goes to a third argon scavenging. This represents the last stage before casting. If the nitrogen content does not lie in the stipulated target range, manganese nitride (MnN, for example, in the form of wires of MnN powder in a steel shell) can be added during the third argon scavenging. The amount of missing nitrogen is then converted into the required amount of MnN (for example, through the required length of MnN wire), which is added to the melt. The MnN is added until the stipulated nitrogen target content or an MnN upper limit of the steel is reached.

Finally, the melt is introduced into a distribution trough in order to cast a slab from the steel melt. The nitrogen content can then rise by about 10 ppm because of leaks and diffusion of atmospheric nitrogen. An upper limit of the amount of dissolved nitrogen in the cast steel slab of about 160 ppm should not be surpassed, because defects in the slab, like cracks or pores, can form at higher nitrogen contents, which lead to undesired oxidation.

The slab cast from the steel melt is then hot rolled and cooled to room temperature. The produced hot strip then has thicknesses in the range of 1 to 4 mm and is optionally wound into a coil. To product packaging steel in the form of a flat steel product in the usual fine and ultrafine thicknesses, the hot strip must be cold rolled, in which a thickness reduction in the range of 50 to more than 90% occurs. Fine sheet is then understood to mean sheet with a thickness of less than 3 mm, and ultrafine sheet has a thickness of less than 0.5 mm. For performance of cold rolling, the hot strip, optionally wound as a coil, is unwound from the coil, pickled and introduced into a cold-rolling device, for example, a cold rolling train. The cold-rolled flat steel product already nitrided to nitrogen concentrations of up to 160 ppm is then used as starting product for subsequent treatment according to the method of the invention, in which the cold-rolled flat steel product is recrystallization annealed in the annealing furnace and at the same time further nitrided in order to increase the nitrogen concentrations to values above 100 ppm and preferably to more than 150 ppm.

1-19. (canceled)

20. A method for production of a nitrided packaging steel from hot-rolled steel product with a carbon content from 400 to 1200 ppm, the method comprising:
cold rolling of the steel product to a flat steel product;
recrystallization annealing of the cold-rolled flat steel product in an annealing furnace, especially a continuous annealing furnace, in which a nitrogen-containing gas is introduced into the annealing furnace and directed at the flat steel product in order to introduce unbonded nitrogen into the flat steel product in an amount corresponding to a concentration of more than 100 ppm, or to increase the amount of unhanded nitrogen in the flat steel product to a concentration of more than 150 ppm;
cooling of the recrystallized annealed flat steel product at a cooling rate of at least 100 K/s immediately after recrystallization annealing.

21. The method according to claim 20, wherein the steel product is a hot-rolled steel nitrided to a nitrogen content of maximum 160 ppm by nitriding of a steel melt.

22. The method according to claim 21, wherein the nitriding of the steel melt occurs by introducing a nitrogen-containing gas and/or a nitrogen-containing solid into the steel melt, especially by introducing nitrogen gas (N₂) and/or calcium cyanamide (CaCN₂) and/or manganese nitride (MnN) into the steel melt.

23. The method according to claim 1, wherein during recrystallization annealing of the cold-rolled flat steel product, ammonia gas (NH₃) is introduced into the annealing furnace and preferably directed onto the flat steel product by at least one spray nozzle.

24. The method according to claim 23, wherein an ammonia equilibrium with a concentration of less than 15 wt % and preferably in the range of 0.05 to 1.5 wt % is set in the annealing furnace by introducing ammonia gas (NH₃).

25. The method according to claim 19, wherein the ammonia equilibrium concentration set in the annealing furnace by introducing ammonia gas (NH₃) is detected with an ammonia sensor and the detected measured value of ammonia equilibrium concentration is used to control the amount of ammonia gas introduced into the annealing furnace per unit time.

26. The method according to claim 20, wherein the weight amount of unbonded nitrogen after nitriding of the cold-rolled flat steel product in the annealing furnace is at least 210 ppm, and especially between 210 and 350 ppm.

27. The method according to claim 20, wherein the concentration distribution of unbonded nitrogen in the nitrided flat steel product over the thickness of the flat steel product deviates by less than ±10 ppm about the value of mean concentration (weight amount) of introduced nitrogen, in which the mean concentration (weight amount) of unbonded nitrogen is more than 150 ppm, and especially between 210 and 350 ppm.

28. The method according to claim 20, wherein the recrystallization annealing of the cold-rolled flat steel product occurs by passing the flat steel product through a continuous annealing furnace in which the flat steel product is heated at least briefly to temperatures above the Ac1 temperature.

29. The method according to claim 20, wherein the cold-rolled flat steel product in the annealing furnace is initially heated in a first heating step to a temperature (Tₕ) below the Ac1 temperature and especially in the range of 600 to 650° C., and in a subsequent holding step is held at this holding temperature (Tₕ) in order to expose the cold-rolled flat steel product to nitriding with the nitrogen-containing gas at the holding temperature (Tₕ).

30. The method according to claim 20, wherein the cold-rolled flat steel product in the annealing furnace is initially heated in a heating step to a holding temperature (Tₕ) above the Ac1 temperature and especially in the range of 740 to 760° C., and held in a subsequent holding step, at this holding temperature (Tₕ), in which the cold-rolled flat steel product is exposed to nitriding with the above-mentioned nitrogen-containing gas during the heating step and/or during the holding step.

31. The method according to claim 29, wherein the cold-rolled flat steel product immediately after nitriding in the annealing furnace is heated in the second heating step to an annealing temperature (T_{g}) above the Ac1 temperature and especially between 740° C.≦T_{g}≦760° C., and then cooled at a cooling rate of more than 100 K/s.

32. The method according to claim 29, wherein the cold-rolled flat steel product in the (first) heating step is heated from ambient temperature to the holding temperature (Tₕ) at a heating rate of 15 to 25 K/s and especially 20 K/s.

33. The method according to claim 31, wherein the cold-rolled flat steel product in the second heating step is heated from the holding temperature (Tₕ) to the annealing temperature (T_{g}) at a heating rate of more than 100 K/s, wherein the heating in the second heating step preferably occurs at a heating rate of more than 150 K/s, and especially inductively at a heating rate between 500 K/s and 1500 K/s.

34. The method according to claim 20, wherein the steel of the hot-rolled steel product contains less than 0.4 wt % manganese, less than 0.04 wt % silicon, less than 0.1 wt % aluminum, and less than 0.1 wt % chromium.

35. A Cold-rolled flat steel product for use as packaging steel and especially produced with the method according to claim 20, with a carbon content from 0.04 to 0.12 wt %, a weight fraction of unbonded nitrogen of more than 0.01 wt %, and preferably more than 0.021 wt %, as well as the following upper limits for the weight fraction of alloy components;
Mn: max. 0.4%,
Si: max. 0.04%, preferably less than 0.02%;
Al: max. 0.1%, preferably less than 0.08%;
Cr: max. 0.1%, preferably less than 0.08%;
P: max. 0.03%, preferably less than 0.02%;
Cu: max. 0.1%, preferably less than 0.08%;
Ni: max. 0.15%, preferably less than 0.08%;
Sn: max. 0.04%, preferably less than 0.02%;
As: max. 0.02%,
S: max. 0.03%, preferably less than 0.02%;
Mo: max. 0.05%, preferably less than 0.02%;
V: max. 0.04%;
Ti: max. 0.05%, preferably less than 0.02%;
Nb: max. 0.05%, preferably less than 0.02%;
B: max. 0.005%;
other alloy components, including contaminant: max. 0.05%, which has a multiphase structure that includes ferrite and at least one of the structure components martensite, bainite and/or troostite as well as optionally residual austenite.

36. The flat steel product according to claim 35, wherein the tensile strength is more than 650 MPa and especially between 700 and 850 MPa, and the elongation at break is more than 5% and especially between 7 and 15%.

37. A device for recrystallization annealing and for nitriding of a flat steel product, especially a steel strip, the device comprising an annealing furnace, through which the flat steel product is passed in a strip running direction, wherein the annealing furnace comprises:
a heating zone for heating of the flat steel product,
a holding zone, in which the heated flat steel product is held at a holding temperature (Tₕ),
a gassing zone with at least one nozzle to expose the flat steel product to a nitrogen-containing gas,
and a cooling device for cooling of the annealed and nitrided flat steel product is arranged downstream the holding zone.

38. The device according to claim 18, wherein the flat steel product, is heated at least in an upstream area of the heating zone by thermal radiation with a heating rate of up to 25 K/s, and wherein a downstream area of the heating zone or in the holding zone, an induction or conduction heating device is arranged, with which the flat steel product can be heated at a heating rate of more than 150 K/s.
